(19) United States
(12) Patent Application Publication
(10) Pub. No.: US 2003/0046857 A1
(43) Pub. Date: Mar. 13, 2003

(54) Scented sinker

(76) Inventors: John E. Paulsen, Winfield, WV (US); Mark E. Schneider, Beavercreek, OH (US)

Correspondence Address: Killworth, Gottman, Hagan & Schaeff, L.L.P., Suite 500, One Dayton Centre, Dayton, OH, 45402-2023, US

(21) Appl. No.: 10/229,918

(22) Filed: Aug. 28, 2002

Related U.S. Application Data
(60) Provisional application No. 60/316,530, filed on Aug. 31, 2001.

(51) Int. Cl. A01K 85/00

(52) U.S. Cl. 43/42.06

(57) ABSTRACT

A scented fishing weight having a housing and a porous insert. The housing is comprised of a material having a high specific gravity relative to water, and includes a channel to accommodate a fishing line. The insert can fit within a recess in the housing, and is capable of receiving and dispersing scented fish attractant. In one configuration, an aperture adjacent the porous insert is smaller than the radial dimension of the porous insert such that the insert can be squeezed then passed through the aperture and into the recess, after which the insert expands back to its pre-squeezed radial dimension. In another configuration, the housing is capped off at the end nearest the insert with the end cap in a press-fit arrangement, while in another, the end cap is threadably engageable with the housing to facilitate the exchange of inserts containing different scents, depending on the type of fish the user is attempting to attract.

### BACKGROUND OF THE INVENTION

This invention relates generally to a sinker used for fishing, and more particularly to a fishing sinker in cooperation with a fishing line near the lure or bait such that a porous insert disposed within the sinker can be filled with fish-attracting scents capable of being dispersed over prolonged periods while in water.

The sport fishing market is a major part of the burgeoning outdoor recreational sport industry, with billions of dollars being spent annually by an ever-increasing number of recreational and professional sport fishers. Products that can help the sport fisher land the elusive “catch” have found rapid and widespread acceptance in the market. One area of the commercial market that has been especially popular is fish attractants, particularly as they relate to fish scents, which exploit the highly developed olfactory system of the fish to attract them by triggering a strike response. Consequently, there are numerous products commercially available to the sport fisher, in liquid, spray and paste/gel form. Typically, the scent is applied on or around the bait, which then diffuses out into the water. Unfortunately, this process must be repeated at frequent intervals, as the scent depletes rapidly, especially in running water, such as streams and rivers. Various devices, including porous foams and tea bag-like pouches, have been developed to retain the scent for longer periods. Scented fish attractors have been added to lures and bobbers to enhance the presence of the attractant around the fish bait. Openings or pores formed in the bobber or lure body permit the scent to diffuse out into the water. Unfortunately, a bobber is not often in close enough proximity with the hook to be of great utility, while scent-impregnated lures can be expensive to manufacture, as well as being relatively inflexible, as a lure with a fixed scent might be useful in attracting only a particular species of fish, while being of no interest to another.

An important technique in fishing is to get the bait, whether live or through an artificial lure, submerged in the water in relatively close proximity to the fish. It is well known that fishing weights (also known as sinkers) are placed near the hook and bait to achieve this purpose. Traditional fishing weights were made of lead, due to their relative density and imperviousness to corrosion or rust formation; however, environmental and health concerns dictate that the weights no longer be made of lead, which could eventually work its way into the food chain. In response, sinkers have been introduced that are made from other metals that possess the necessary density and corrosion resistance without lead's detrimental toxicity. In addition, prior art sinkers have incorporated fish-attracting scents to improve their performance. For example, U.S. Pat. No. 3,953,934 to Visser discloses a sintered metal sinker where the pores are impregnated with various fish attracting scents. The sinker is immersed in a scent-rich liquid, and a vacuum is pulled to ensure an adequate differential pressure to force the scent into the interstices of the sintered metal. U.S. Pat. No. 5,555,670 to Troutman, Jr. discloses a boat anchor that includes a hollowed-out cylinder for placing a quantity of fish-attracting material inside. U.S. Pat. No. 4,138,794 to Chiodini discloses a spring-loaded combination sinker and scented fish attractant dispenser. While all of these improve the performance of the sinker, they also introduce significant cost, complexity or impracticality of use, thus reducing their benefit to the sport and recreational user. The extra complexity and concomitant cost are especially troublesome for the recreational fisher, where numerous sinkers of various sizes and weights must be kept on hand to both perform under myriad conditions and replenish those that become frequently lost due to line breakage, inadvertent separation from the line, or misplacement in or around a tackle box.

Consequently, what is needed is a sinker or fishing weight that is simultaneously capable of dispersing fish scent for extended periods such that the fisher need not have to repeatedly recharge the weight, bait, hook or line with scent. Furthermore, the need exists for such a sinker to be inexpensive, as well as easy to install, operate and maintain.

### SUMMARY OF THE INVENTION

This need is met by the present invention wherein a fishing weight without the disadvantages of the prior art is described. By permitting the use of a porous insert to provide a charge of scented fish attractant, the usefulness during a fishing session is prolonged, as the mostly enclosed charge will not deteriorate rapidly upon exposure to water. The simplistic construction ensures that “per unit” cost is kept extremely low, ensuring ease of replacement in event of loss. Moreover, by making the porous insert readily available to a user, recharging of the scent can be done quickly and efficiently without having to resort to disassembly of the sinker or complex tools to reach the insert. In accordance with one embodiment of the present invention, a fishing weight with a metal housing and a porous insert disposable within the housing are disclosed. A channel is disposed in the housing, and extends from one end to the other to permit connection of the weight to a fishing line. The insert fits within a recess in the housing, and can hold scented fish attractant.

Optionally, the second aperture is defined by a flange disposed in the housing. The second aperture defines a smaller radial dimension than that of the porous insert, thereby forming a partial enclosure in the recess. Once the insert is squeezed such that its radial dimension shrinks below that of the second aperture, it can be passed through the aperture and into the recess, where the partial enclosure maintains the porous insert in the recess. Preferably, the housing, the channel extending through the housing and the recess disposed in the housing are of one-piece construction such that there are no moving or removable parts. This, in addition to the recess being of a fixed volume, contributes to the overall simplicity of the weight. Alternatively, the insert may be kept in place by an end cap (or plug) that engages a complementary surface of the housing. In such a configuration, the weight takes on a three-piece construction, including the housing, end cap and insert. Openings in the end cap permit exposure of the porous insert to the ambient environment, thereby facilitating both a path for the water to carry away the fish scent that can be impregnated into the insert, as well as easy access for the user to recharge the insert with more scented fish attractant. In one form, the end cap is press-fit such that it engages the inner wall of the recess. In another form, the plug is threadably engageable with the recess. The housing can be axisymmetric, and in the form of a bullet defined by a lower cylindrical portion and a frustro-conical upper portion. In addition, the porous insert includes a channel that aligns with the channel in the housing such that both channels define a continuous path from the first aperture to the second aperture, where at least one of the first or second apertures includes a bevelled edge. The metal making up the housing is substantially free of porosity such that the weight is substantially fully densified, and should be of a relatively dense, corrosion-resistant composition, such as predominantly bismuth, tungsten, brass or steel. Furthermore, the end cap and the porous insert are configured such that upon their insertion into the recess, the exterior profile of the housing is substantially unchanged.

According to another embodiment of the present invention, a scented fishing weight with a housing and a porous insert disposed within the housing are disclosed. As before, the housing includes a channel extending longitudinally through the housing such that the channel can accommodate a fishing line. The housing also includes a recess disposed therein, the recess defining a radial dimension that is larger than a radial dimension defined in the channel. Also as with the previous embodiment, the porous insert is configured to be disposed in the recess, and can accept a fish scent therein such that upon fluid communication between the insert and water, at least a portion of the fish scent is dispersed to the water. Optionally, an end cap can be inserted into the recess to keep the insert in place. The end cap may either be frictionally fit into or threadably engageable with the recess, and may further include at least one grippable element to facilitate tool-free engagement with the recess. The grippable element may be in the form of a protrusion that sticks up from at least one surface of the end cap.

According to another embodiment of the present invention, a method of fishing with a scented sinker is disclosed. The method includes the steps of configuring the scented sinker to include a metal housing, al channel extending through the housing, a recess disposed in the housing, and a porous insert configured to be disposed in the recess. The porous insert is configured to accept a fish scent therein such that upon fluid communication between the insert and water, at least a portion of the fish scent is dispersed to the water. Additional steps include placing a scented fish attractant in the porous insert, coupling the scented fishing sinker to a fishing line, attaching at least one hook for catching fish, and immersing the sinker and hook in water to be fished such that the scented fish attractant is released into the water from the porous insert in order to attract fish. Optionally, the housing can be configured to have a partial enclosure in the recess by configuring the second aperture to be formed within a flange that is disposed in the housing. The second aperture has smaller radial dimension than that of the porous insert, thus, once the insert is squeezed such that its radial dimension shrinks below that of the second aperture, it can be passed through the aperture and into the recess, where the partial enclosure maintains the porous insert in the recess. Alternatively, the method includes the steps of engaging an end cap with the housing such that the end cap prevents the porous insert from disengaging from the recess. Moreover, the end cap can be configured to be threadably engaged to the recess. In addition, the step of engaging the end cap with the housing is accomplished by grasping protrusions disposed on a surface of the end cap and turning by hand. The metal housing is also formed in such a way to ensure that it is substantially free of porosity. the second aperture is defined by a flange disposed in the housing.

According to another embodiment of the present invention, a method of making a scented sinker is disclosed. The method comprises the steps of configuring a metal housing to be substantially non-porous, placing an axial channel extending through the housing such that the axial channel defines a first aperture in the housing, placing a recess in the housing such that the recess defines a second aperture in the housing, including in the recess an axial channel therethrough that is coupled to the axial channel extending through the housing such that a continuous path configured to accept a fishing line therethrough is formed between the first and second apertures, configuring a porous insert adapted to accept a fish scent therein to be disposed in the recess, and placing the porous insert in the recess. Optionally, an end cap can be engaged with the housing such that the end cap prevents the porous insert from disengaging from the recess.

These features and advantages of the invention will become apparent from the following detailed specification when read together with the accompanying drawings.

### BRIEF DESCRIPTION OF THE DRAWINGS

FIG. 1A is a side cutaway of an embodiment of the present invention, showing the housing with porous insert;

FIG. 1B is a side cutaway of an alternate embodiment of the present invention;

FIG. 2A is a bottom end view of the embodiment of FIG. 1A;

FIG. 2B is a bottom end view of the embodiment of FIG. 1B;

FIG. 3 is a perspective view showing the embodiment of FIG. 1A mounted on a fishing line in relation to the lure and hook;

FIG. 4 is an exploded view of the embodiment of FIG. 1B; and

FIG. 5 is a side cutaway of another alternate embodiment of the present invention, showing a threaded end cap.

### DETAILED DESCRIPTION OF THE PREFERRED EMBODIMENTS

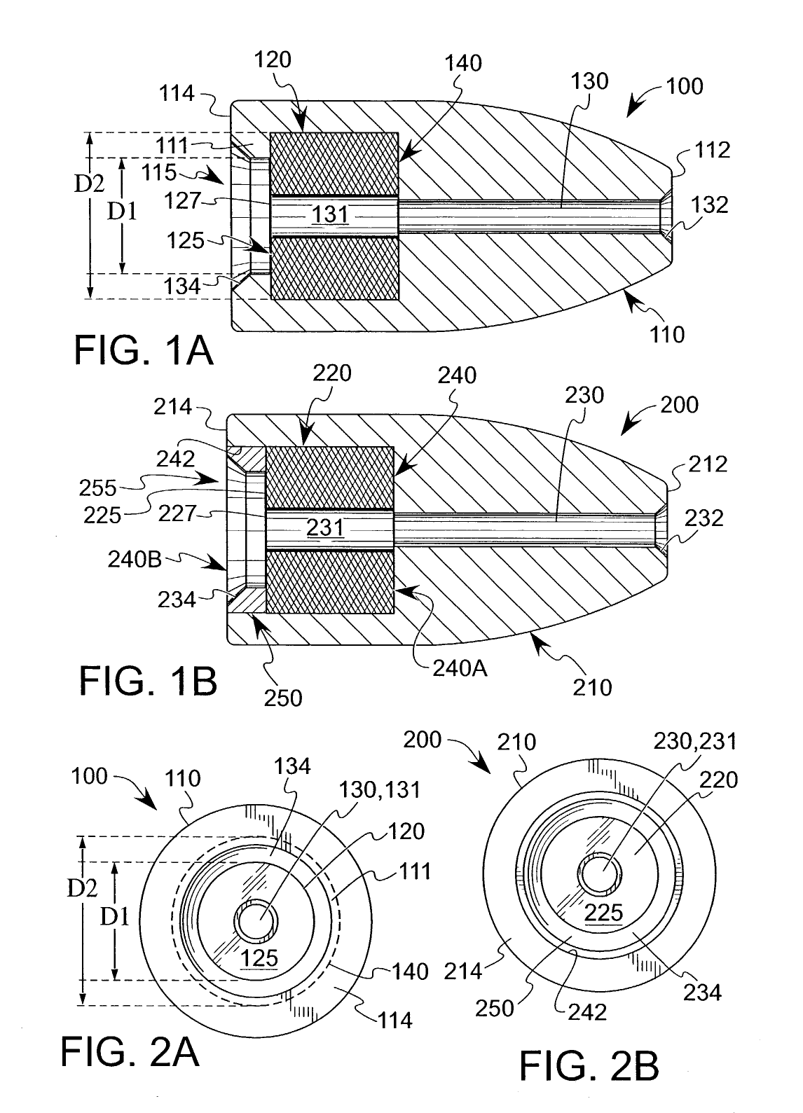

Referring first to FIGS. 1A, 2A and 3, a fishing weight 100 is configured in two parts, including a housing 110 and an insert 120 capable of holding a fish attracting scent (not shown). By having the scented fish attractant disposed in a separate insert rather than being integrated into the housing (such as through a porous housing body), a user can rapidly recharge the attractant without having to remove the weight 100 from a fishing line 102. This is especially valuable when the user is attempting to catch different species of fish and needs a quick way to recharge or change the fish attractant. In addition, by not having to rely on the housing 110 for the fish scent, time-consuming recharging of the scent or expensive disposal of an otherwise functional fishing weight is abrogated. The combined cylindrical and frustro-conical shape of the weight provides an overall bullet-shape that allows greater exposure of the insert 120 to the water (not shown), as well as promoting a lower drag profile, which could be of benefit in trolling situations, as well as helping to avoid snagging on various underwater obstructions. The size of fishing weight 100 shown in the figures is greatly enlarged for clarity; by way of example, the fishing weight of the present invention can be between one half and two inches long, and one quarter and one inch in diameter, although it is contemplated that other sizes could be made, according to need. The housing 110 of fishing weight 100 is made of a dense material, such as brass, tungsten, bismuth or steel. In addition to possessing enough ballast to cause the fishing line 102, bait 104 and hook 106 to submerge in water, the housing 110 should be able to withstand the long term corrosive effects of fresh or salt water. The material making up the housing is preferably made from a substantially fully densified, non-porous material, thereby allowing the weight 100 to occupy a minimum volume for a given weight. In addition to taking up less space, weights made from cast or forged products avoid complex formation steps, such as sintering that results in a more expensive finished part. A centrally disposed axial channel 130 extends from the top end 112 of the housing 110 to the bottom end 114. The intersection of channel 130 and top end 112 is beveled 132 to minimize abrasion and subsequent fraying of the fishing line 102, as is the intersection at the bottom end, showing bevel 134. Fishing line 102 can be placed through the channel 130 in order to secure the weight 100 to it.

Near the bottom end 114 of housing 110 is an enlarged recess 140 into which the insert 120 is disposed. The insert 120 is preferably of a porous structure, such as a fibrous pad or sponge-like material. The insert 120 is held in place in recess 140 by a flange 111 at bottom end 114 of housing 110 such that an aperture 115 defined therein that has a radial dimension D1 that is smaller than the radial dimension D2 of insert 120. The insert 120 is squeezed prior to placement into recess 140 such that while squeezed, its radial dimension is less than D1 so that it may pass flange 111 on its way to its final resting place within recess 140, after which it expands to its pre-squeezed radial dimension D2. The difference in radial dimensions D1 and D2 define an exposed surface 125 of insert 120. An aperture 127 disposed within insert 120 forms an axial channel 131 to create a contiguous path with channel 130 to avoid interfering with the connection with fishing line 102. In contrast to prior art fishing weights that are connected on the outside of the housing to a fishing line, the axial channels 130, 131 in weight 100 allow the fishing line 102 to pass in close proximity to the insert 120 so that the fishing line 102 will pick up additional scented fish attractant. In addition, in circumstances where the weight 100 is moving through the water (such as during trolling and related maneuvers), the axial channels 130, 131 can be sized relative to the fishing line 102 to allow water to pass through, thereby dispersing more fish scent into the adjacent water. Upon insertion of the insert 120 into the recess 140, the exterior profile of housing 110, which is substantially bullet-shaped, does not change.

Referring with particularity to FIG. 2A, a view of the bottom end of fishing weight 100 is shown, highlighting how the insert 120 is fit within the recess 140, as well as exposed to the ambient environment, typically air or water (neither of which are shown). The material used for the insert 120 can be any water-impervious and environmentally acceptable material, such as paper and related products, cotton, cloth and related fabric, or various synthetics, such as polyester, polycarbonates, polytetrafluroethylene (PTFE), nylon or cellulose esters. The relatively large exposed surface 125 of insert 120 ensures that not only will an ample supply of fish attracting scent be dispersed into the water, but when it comes time to recharge the insert 120 with more scent, the user has easy, relatively unrestricted access to the porous medium that makes up insert 120. The dashed circular line defines the recess 140, against which insert 120 can abut. From this view, it can be readily appreciated that radial dimension D2 of insert 120 is such that once the insert 120 is placed through the aperture 115 with radial dimension D1 and into recess 140, it will not become dislodged under normal use.

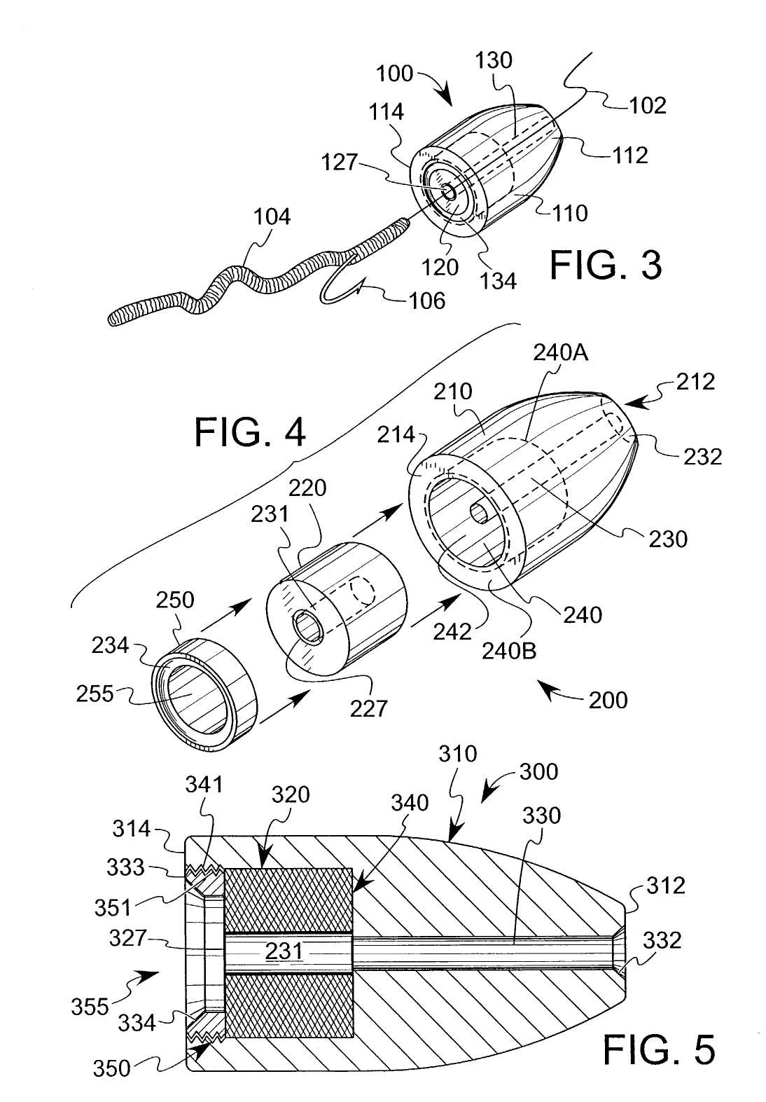

Referring with particularity to FIG. 3, the interrelationship between the housing 110, insert 120, fishing line 102, lure 104 and hook 106 are shown. as is the placement of the channel 130 through housing 110 and aperture 127 in the insert 120. The construction of the housing 110 and the contact between the insert 120 and the water are such that complex moving parts or expensive metal forming schemes are not required. Similarly, reliance on a porous structure in the housing 110 is done away with. For example, the insert 120 is of sufficient size and wetted area such that additional fish scent exposure paths and related bores need not be present to achieve a high degree of dispersal of fish attractant into the space surrounding the weight 100. By avoiding such additional structure in the housing 110, not only is the cost kept lower, but cleanliness of the weight 100 is enhanced, as there are fewer locations for dirt, grime or organic products to build up. The fixed dimension of recess 140 further ensures that the weight 100 is of a simple, easy-to-use and inexpensive design.

Referring next to FIGS. 1B, 2B and 4, an alternate embodiment 210 of the housing is shown, where the weight 200 is of three-part construction including an insert 220 that fits within recess 240, held therein by an end cap 250 (alternately referred to as a plug). End cap 250 is configured to engage the inner surface 242 of recess 240, such as by friction fit. Unlike the configuration shown in FIGS. 1A and 1B, there is no flange to partially define an end wall in recess 240. Instead, the recess 240 extends cylindrically from a first end 240A to a second end 240B, the latter coextensive with bottom end 214 of housing 210. The end cap 250 is designed to fit snugly within the recess 240, and includes an aperture 255 that is oversized to define an exposed surface 225 of insert 220. In other aspects, the top end 212, insert aperture 227, axial channels 230, 231 and bevels 232, 234 function similar to their FIG. 1A counterparts, and accordingly will not be discussed in further detail.

Referring with particularity to FIG. 2B, a view of the bottom end of the alternate embodiment 200 of the fishing weight of FIG. 1B is shown. As discussed above, the recess 240 is of a generally cylindrical shape that extends all the way to the bottom end 214 of housing 210, thereby permitting slideable insertion and removal of insert 220 into recess 240. The outer radial surface of insert 220 abuts the inner surface 242 of recess 240, while the presence of end cap 250 ensures that the insert 220 will not slip out of housing 210 during use. It will be appreciated by those skilled in the art that porous insert 220 can also be sized to frictionally engage the inner surface 242 of recess 240, thereby enhancing the secure fit between the porous insert 220 and the housing 210.

Referring next to FIG. 5, an alternate embodiment of the three-piece design of FIG. 1B is shown. It was previously stated that the end cap fits snugly within the space defined by the inner wall of the recess, and that it can do so by either being press-fit or threadably-engaged, the latter as shown with particularity in FIG. 5. The threaded end cap 350 configuration comprises external threads 351 that cooperate with threads 341 disposed on the inner wall of the recess 340. This threaded configuration facilitates quick removal of the porous insert 320 such that if another insert (not shown) containing a different scent needed to be placed inside, it could be done so quickly, and without the need of any tools. Grippable surfaces (not shown) such as a protruding element on the end surface 333 or the bevelled surface 334 of the threaded end cap 350 can further allow easy insertion and removal by the user without the need for tools, as the user may merely grasp the protrusion and turn the end cap 350 so that the complementary threaded surfaces engage or disengage, depending on the direction of the turning. This would be of great benefit to a sport fisher who is using different scents to attract different kinds of fish, and needs to either recharge or replace the porous insert 320 on a boat where space and time constraints would otherwise hamper such modifications. As previously mentioned, the continuous path formed by the axial channels 330, 331 can be sized to permit water to flow therethrough to pick up additional fish scent. In other respects, the embodiment of the present invention is similar to that shown in FIGS. 1B, 2B and 4.

Having described the invention in detail and by reference to preferred embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A fishing weight comprising:
a metal housing comprising:
a channel extending through said housing and configured to facilitate securing said weight to a fishing line, said channel defining a first aperture in said housing; and
a recess disposed in said housing, said recess defining a second aperture in said housing; and
a porous insert configured to be disposed in said recess, said porous insert configured to accept a fish scent therein such that upon fluid communication between said insert and water, at least a portion of said fish scent is dispersed to said water.

2. A fishing weight according to claim 1, wherein said housing is axisymmetric.

3. A fishing weight according to claim 1, wherein first aperture is smaller than said second aperture.

4. A fishing weight according to claim 1, wherein said second aperture is defined by a flange disposed in said housing, said second aperture defining a smaller radial dimension than that of said porous insert to form a partial enclosure in said recess that, upon placement of said porous insert in said recess, maintains said porous insert therein.

5. A fishing weight according to claim 1, further comprising a plug adapted to fit into said recess, said plug defining at least one fluid communication path therein to allow said fish scent in said porous insert to disperse through said plug and into said water.

6. A fishing weight according to claim 5, wherein said plug is press-fit into said recess.

7. A fishing weight according to claim 5, wherein said plug is threadably engageable with said recess.

8. A fishing weight according to claim 5, wherein said plug and said porous insert are configured such that upon insertion of both into said recess, the exterior profile of said housing is substantially unchanged.

9. A fishing weight according to claim 1, wherein said porous insert includes a channel that aligns with said channel in said housing such that both said channels define a continuous path from said first aperture to said second aperture.

10. A fishing weight according to claim 1, wherein said metal making up said housing is substantially free of porosity.

11. A fishing weight according to claim 10, wherein at least one of said first or second apertures includes a bevelled edge.

12. A fishing weight according to claim 10, wherein said metal making up said housing is predominantly bismuth, tungsten, brass or steel.

13. A fishing weight according to claim 1, wherein said housing is substantially bullet-shaped.

14. A fishing weight according to claim 1, wherein said housing, said channel extending through said housing and said recess disposed in said housing are of one-piece construction.

15. A fishing weight according to claim 1, wherein said recess comprises a fixed volume.

16. A scented fishing weight comprising:
a housing with a density greater than water, said housing comprising:
an axial channel extending longitudinally through said housing and configured to facilitate securing said weight to a fishing line, said axial channel defined by a first radial dimension; and
a recess disposed in said housing, said recess defining a second radial dimension that is larger than said first radial dimension; and
a porous insert configured to be disposed in said recess, said porous insert configured to accept a fish scent therein such that upon fluid communication between said insert and water, at least a portion of said fish scent is dispersed to said water.

17. A scented fishing weight according to claim 16, further comprising a plug adapted to fit into said recess, said plug defining an aperture therein to allow said fish scent in said porous insert to disperse through said plug and into said water.

18. A scented fishing weight according to claim 17, wherein said plug is threadably engageable with said recess.

19. A scented fishing weight according to claim 17, further comprising at least one grippable element disposed on said plug to facilitate tool-free engagement of said plug with said recess.

20. A scented fishing weight according to claim 19, wherein said at least one grippable element disposed on said plug is a protrusion from at least one surface of said plug.

21. A method of fishing using a scented sinker, said method including:
configuring said scented sinker to include:
a metal housing;
a channel extending through said housing and configured to facilitate securing said sinker to a fishing line, said channel defining a first aperture in said housing;
a recess disposed in said housing, said recess defining a second aperture in said housing; and
a porous insert configured to be disposed in said recess, said porous insert configured to accept a fish scent therein such that upon fluid communication between said insert and water, at least a portion of said fish scent is dispersed to said water;
placing a scented fish attractant in said porous insert;
coupling said scented fishing sinker to a fishing line;
attaching at least one hook for catching fish; and
immersing said sinker and hook in water to be fished such that said scented fish attractant is released into said water from said porous insert in order to attract fish.

22. A method according to claim 21, further comprising engaging an end cap with said housing such that said end cap prevents said porous insert from disengaging from said recess.

23. A method according to claim 22, further comprising configuring said end cap to be threadably engaged to said recess.

24. A method according to claim 21, wherein said step of engaging said end cap with said housing is accomplished by grasping protrusions disposed on a surface of said end cap and turning by hand.

25. A method according to claim 21, further comprising configuring said metal housing to ensure that it is substantially free of porosity.

26. A method according to claim 21, comprising the additional step of forming a partial enclosure in said recess by configuring said second aperture in said housing to be defined by a flange disposed in said housing, said second aperture defining a smaller radial dimension than that of said porous insert such that said porous insert, upon placement in said recess, remains therein.

27. A method of making a scented sinker, said method comprising:
configuring a metal housing to be substantially non-porous;
placing an axial channel extending through said housing such that said axial channel defines a first aperture in said housing;
placing a recess in said housing such that said recess defines a second aperture in said housing, said recess including an axial channel therethrough that is coupled to said axial channel extending through said housing such that a continuous path is formed between said first and second apertures, said continuous path configured to accept a fishing line therethrough;
configuring a porous insert to be disposed in said recess, said porous insert adapted to accept a fish scent therein such that upon exposure of said insert to water, at least a portion of said fish scent is dispersed to said water; and
placing said porous insert in said recess.

28. A method according to claim 27, comprising the additional step of engaging an end cap with said housing such that said end cap prevents said porous insert from disengaging from said recess.
